(19) United States
(12) Patent Application Publication
(10) Pub. No.: US 2020/0095017 A1
(43) Pub. Date: Mar. 26, 2020

(54) Packaging divided in its direction of height and method for producing such a packaging

(71) Applicants: Ralf Schauties, Halle (DE); Lars Wellerdiek, Halle (DE)

(72) Inventors: Ralf Schauties, Halle (DE); Lars Wellerdiek, Halle (DE)

(21) Appl. No.: 16/576,801

(22) Filed: Sep. 20, 2019

(30) Foreign Application Priority Data
Sep. 21, 2018 (DE) 10 2018 123 344.2

(51) Int. Cl. B65D 19/38; B65D 19/20; B31B 50/78

(52) U.S. Cl. CPC B65D 19/38; B65D 19/20; B31B 50/784; B31B 2120/302; B65D 2519/00194; B65D 2519/00497; B65D 2519/00537; B65D 2519/00159

(57) ABSTRACT

A packaging that can be unfolded and forms a circumferentially closed ring has vertically positioned sidewalls that are connected to each other by commonly embodied corners of a spatial shape. In at least two or more corner regions, support strips extending across a corner and provided with upwardly and downwardly projecting clamping flaps are pushed onto the top edges of the bottom sidewalls, the upwardly projecting clamping flaps form between them an insertion channel extending along the extension of the support strip into which the top sidewalls can be inserted, wherein the length dimensions and the spatial shape of the sidewalls below and above the strip plane correspond with each other. The sidewalls positioned on top of each other and connected by the support strips to each other form a common packaging with commonly formed flat outer surfaces, respectively.

### BACKGROUND OF THE INVENTION

The present invention relates to a packaging that can be unfolded from a flat folded position to a polygonal spatial shape and forms a circumferentially closed ring with vertically positioned sidewalls that are connected to each other by commonly embodied corners of the spatial shape as well as to a method for producing a packaging divided in the direction of height.

Packagings of the aforementioned kind are known in the prior art and are preferably produced from carton or corrugated cardboard. The packagings are usually comprised of four flat sidewalls which can be folded flat, for example, with two sides on top of each other, respectively, in a space-saving way in bundles of several packagings in order to store and to transport the packagings and can be unfolded for use, for example, to cubic or cuboid spatial shapes. Into the interior that is formed and bounded thereby, the goods to be packaged are then placed so that during the future storage and transport they are protected better from possible damages. Such packagings are available in various sizes on the market. However, they must then be procured and stored in the respectively desired size.

Instead of annular packagings, also cubic or cuboid collapsible boxes, preferably of corrugated cardboard, are known in which flaps located at the top and bottom ends are folded in order to form a bottom and to close the box. When filling the box, that flaps are annoying because they are projecting laterally.

A disadvantage of the known packagings and collapsible boxes is that they often have higher sidewalls than a height of the individual goods packages that are to be packaged in the packaging or in the collapsible box. Because of the usual cargo bay height of conventional trailers of 2.30 m and the thickness of a europallet of 15 cm, collapsible boxes with a respective height of 1 m are frequently used in order to package and ship goods. Such collapsible boxes can be shipped stacked in two with a respective europallet underneath. The box height of 1 m is however very obstructive when several goods packages are to be placed into a box and stacked therein. It is then very cumbersome for workers that must package the goods for shipping to again and again bend over down into the box in order to place and stack therein individual goods packages. They first have to lift the respective goods by more than 1 m, can only thereafter put them down into the collapsible box, and, in doing so, must bend always across the higher wall of the collapsible box or the packaging. Also, for packaging one or several goods, packagings or collapsible boxes are frequently used that is much too high for them. Since the freight rates in shipping are frequently calculated based on freight volume, the packagings that are too high and too voluminous cause avoidable shipping costs.

It is the object of the present invention to provide a packaging that facilitates the packaging work.

### SUMMARY OF THE INVENTION

The object is solved for a packaging of the aforementioned kind in that the sidewalls in their direction of height comprise a division into a bottom and a top sidewall and
support strips that extend across a corner are pushed onto top edges of the bottom sidewalls in at least two or a plurality of corner regions,
the support strips comprise clamping flaps formed at their inner and outer edge and extend from the strip plane in a direction toward the top and toward the bottom,
the clamping flaps oriented toward the bottom delimit between them an insertion channel following the extension of the support strip into which the bottom sidewalls are inserted that form a closed ring, are unfolded from a flat folded position to a spatial shape, and are located below the strip plane and connected to each other by this commonly embodied corner,
the clamping flaps oriented toward the top delimit between them an insertion channel following the extension of the support strip into which the top sidewalls are inserted that form a closed ring, are unfolded from a flat folded position to a spatial shape, and are located above the strip plane and connected to each other by this commonly embodied corner,
wherein the length dimensions and the spatial shape of the sidewalls below and above the strip plane correspond to each other so that the sidewalls which are arranged on top of each other and are connected to each other by the support strips form a common packaging with flat, commonly formed outer surfaces, respectively.

The object is solved by a method for producing a packaging with sidewalls that are divided in their direction of height according to the following method steps:
erecting a circumferentially closed ring of sidewalls from a flat folded position to a polygonal spatial shape with vertically positioned sidewalls,
pushing support strips extending across a corner onto the top edges of the sidewalls in at least two or more corner regions, wherein for this purpose support strips are used which comprise clamping flaps that are formed at their inner and outer edge and extend from the strip plane in a direction toward the top and toward the bottom, the clamping flaps oriented toward the bottom delimit between them an insertion channel following the extension of the support strip into which the bottom sidewalls are inserted that are located below the strip plane and connected to each other across this commonly embodied corner, the clamping flaps oriented toward the top delimit between them an insertion channel following the extension of the support strip into which the top sidewalls, which are located above the strip plane and connected to each other across this commonly embodied corner, will be inserted in the next method step,
inserting a circumferentially closed ring of sidewalls that has been unfolded beforehand from a flat folded position to a polygonal spatial shape with vertically positioned sidewalls into the insertion channel formed by the clamping flaps oriented toward the top, wherein the length dimensions and the spatial shape of the sidewalls located below and above the strip plane correspond to each other so that the sidewalls positioned on top of each other and connected to each other by the support strips form a common packaging with commonly formed flat outer surfaces, respectively.

By dividing the sidewalls in their direction of height, the sidewalls can be constructed of a plurality of closed rings of sidewalls to a desired height. When the first ring has a height, for example, of only 50 cm, the goods packages to be packaged can be placed much easier into this ring and stacked therein. The packaging persons must no longer lift the goods packages across sidewalls that are too high and then bend deep down into a box in order to place the goods package therein.

When in this description and the claims a ring is mentioned, this means in particular material sections connected to a ring or a material strip that is connected at opposed ends to a ring, wherein the partial material sections forming the sidewalls are connected to each other at the edges to a neighboring sidewall by a type of hinge so that the ring can be used in angular spatial shapes. The hinge can be provided by folding the material of the ring or by a portion of reduced material strength present in this region, or special materials are introduced in the hinge region, for example, a film or the like, which enables a hinge-like pivoting of a sidewall in relation to a neighboring sidewall. Due to the hinge-type connection of the sidewalls to each other, a ring can be folded in a space-saving way but also erected to its desired packaging volume.

When after providing the first ring a greater height of the sidewalls of the packaging is required, it is sufficient to push support strips in the corner regions onto the top edges of the sidewalls in order to then push a further ring of sidewalls from above onto the support strips. Here, a second ring with a height, for example, of 50 cm can be used, or a ring with a height of the sidewalls of 25 cm is only used. As needed, also a third or a fourth ring with a suitable height of the sidewalls can be attached correspondingly. In this way, packagings with a total height of the sidewalls of, for example, 75 cm, 1 m or other heights can be constructed.

By use of the rings pushed onto each other, the sidewalls are divided in horizontal direction but they are sufficiently strong for packaging purposes because the rings are sufficiently strongly connected to each other by the clamping flaps. The support strips with the clamping flaps formed thereat can be pushed easily in corner regions of the packagings onto the top edges of the sidewalls. By support strips in at least two corners of a packaging with a quadrangular cross section, the top ring of sidewalls is already fixed with a certain strength in its spatial position. However, a better fixation results when the support strips are provided in the corner region on the top edges of the sidewalls, for example, at all four corners of a packaging with a quadrangular base surface. By attaching the support strips in the corner region, torsional forces acting on the packaging and other loads are transmitted better and more uniformly to the rings connected to each other by the support strips and to the corresponding sidewalls.

Pushing the support strips onto the bottom ring and inserting the top ring into the clamping flaps of the support strips can be quickly done by the packaging persons. The connection of the components is realized without tools. The required rings of sidewalls and support strips made available in boxes for pick-up can be easily provided at each packaging work station.

When rings of sidewalls with different height dimensions are available for packaging of goods packages, the packaging persons can adjust the height of the packaging by suitable combinations of ring heights precisely as high as is required for the respective goods to be packaged. In this way, it can be avoided that shipping units are handed over to a shipping company for shipping that have a sidewall height of 1 m but only goods are packaged therein that have a height of less than 50 cm. When in such cases the height of the packaging is limited to 50 cm, the shipping costs calculated by the shipping company drop by 50% when calculated based on volume.

A packaging furnished completely with goods can subsequently be finally packaged with straps, stretch films and other means suitable for fixation of the packaging.

According to an embodiment of the invention, the packaging is placed with the bottom sidewalls in a bottom part. The bottom part can be plate, a tub with sidewalls projecting upwardly at the corners or the lateral edges, or a pallet. The first ring can be connected to the bottom part by suitable connecting aids such as clamps, glue, adhesive strips, insertion tabs with locking noses that are inserted into prepared slots, or the like, or the first ring is simply placed onto the bottom part and the fixed connection is realized only at the end of the packaging process by straps, strapping, stretch film or the like.

According to an embodiment of the invention, a cover part is placed onto the top sidewalls of the packaging. The cover part can be a flat plate or a cover with sidewalls that are projecting downwardly at the corners or the lateral edges and overlap the lateral parts of the rings. For the attachment of the cover part to the remaining packaging, the aforementioned explanations to the bottom part apply likewise.

According to an embodiment of the invention, slip-reducing elements are applied to the top side of the cover part. When several packagings are stacked on each other during transport, the slip-reducing elements can prevent or at least reduce the risk that the packagings slide on each other and a packaging falls down from a packaging underneath.

According to an embodiment of the invention, the clamping flaps formed at the inner and outer edges have a spacing to neighboring clamping flaps arranged at the same side of the inner or outer edge. The clamping flaps are not formed continuously across the complete length of the support strips. This saves material for the support strips. For the same amount of material being used, the support strips can become longer whereby they can transmit the forces acting on them more uniformly and not only localized in the direct corner region onto the rings connected by the support strip.

According to an embodiment of the invention, the clamping flaps which are formed opposite each other at the inner and outer edges are arranged displaced relative to each other. Due to the displacement, the holding forces of the clamping flaps act alternately from the exterior and interior across the length of the support strip onto the surfaces of the rings contacted by the clamping flaps. Since the sidewalls bulge slightly under the acting load in the force direction, a slight corrugated shape of the sidewalls in the insertion region of an insertion channel is produced, whereby the frictional connection between the surfaces of the clamping flaps and the sidewalls is increased and a type of form fit connection of the sidewall in the insertion channel is produced which makes relative movements of the sidewall in the insertion channel difficult. The stability and robustness of the connection of the rings to each other via the support strips is thereby increased.

According to an embodiment of the invention, the support strips have bending locations with material cutouts or portions of reduced material strength. The support strips can be produced inexpensively as an injection molded extruded section as endless rod material but also as an individual part by an injection molding method. So that the support strips can be processed despite of this as a component connecting across a corner in a packaging in the corner region, it is required to embody a support strip produced as an endless extruded section or as an individual part by an injection molding method in such a way that it can be bent as an extruded section into a corresponding shape. This is possible in that a support strip in the region of a provided bending location comprises material cutouts or portions with reduced material strength which simplify a corresponding bending of the extruded section of the support strip. In case of an endless extruded section, the material cutouts or portions with reduced material strength must be introduced into the extruded section after exit of the endless section from the tool.

According to an embodiment of the invention, in the region of a bending location neighboring clamping flaps located at the outer edge and forming a corner are connected to each other by a film hinge. The film hinge serves the purpose of transmitting forces acting on a leg of a support strip across the corner to the leg at the other side of the corner. In this way, the film hinge contributes to increasing the strength of the connection of the two rings with each other.

According to an embodiment of the invention, clamping flaps embodied at the inner edge project higher above the support strip than the clamping flaps embodied at the outer edge. When placing a top ring onto a bottom ring with the already attached support strips, the higher clamping flaps aid in initially positioning with as precise a fit as possible and aligning as precisely as possible the top ring above the bottom ring and the clamping flaps prior to pushing the top ring into the insertion channel correlated with it. The better the top ring is aligned prior to pushing into the insertion channel, the simpler and faster is it to push the top ring into the insertion channel.

According to an embodiment of the invention, the clamping flaps comprise reinforcement ribs. Due to the reinforcement ribs, the clamping flaps as a whole are stiffer without increasing significantly the material expenditure for the support strips for this purpose. Due to the greater stiffness, the support strips as a whole are more stable, less at risk of breakage, and increase the protective action of the packaging for the goods packaged therein.

According to an embodiment of the invention, the clamping flaps comprise at their inner side facing the support strip clamping noses or barbs projecting from the surrounding surface of the clamping flap. When inserting the sidewalls into the insertion channel, the clamping noses or barbs at the clamping flaps are supposed to push or even penetrate into the material of the sidewalls so that the ring can be pulled out from the insertion channel only with significantly increased expenditure. A ring is therefore held better in its installed position and the packaging as a whole is more stable.

According to an embodiment of the invention, the sidewalls are made of corrugated cardboard. Corrugated cardboard is a material that is well-tried and particularly suitable for packaging purposes, that, on the one hand, is sufficiently lightweight in order not to unnecessarily make difficult the packaging and the transport, on the other hand, however provides a high protection potential against damages of the goods packaged therein.

According to an embodiment of the invention, the clamping flaps comprise a shaped portion through which the insertion channel at its insertion end is widened in relation to the deeper sections. The widened portion makes it easier to thread the rims of the rings into the insertion channel.

Further features of the invention result from the claims, the Figures, and the description of the subject matter. All features and feature combinations mentioned above in the description as well as the features and feature combinations which are mentioned in the following in the figure description and/or shown solely in the Figures are usable not only in the respectively indicated combination but also in other combinations or even individually.

### BRIEF DESCRIPTION OF THE DRAWING

The invention will now be explained with the aid of a preferred embodiment as well as with reference to the attached drawings in more detail. It is shown in:

FIG. 1: a pallet with a bottom part;

FIG. 2: the bottom part illustrated in FIG. 1 with the bottom ring placed therein;

FIG. 3: a support strip with clamping flaps formed thereat;

FIG. 4: a packaging with top ring additionally attached in comparison to the illustration of FIG. 3; and

FIG. 5: a packaging with an additional cover part.

### DESCRIPTION OF THE PREFERRED EMBODIMENTS

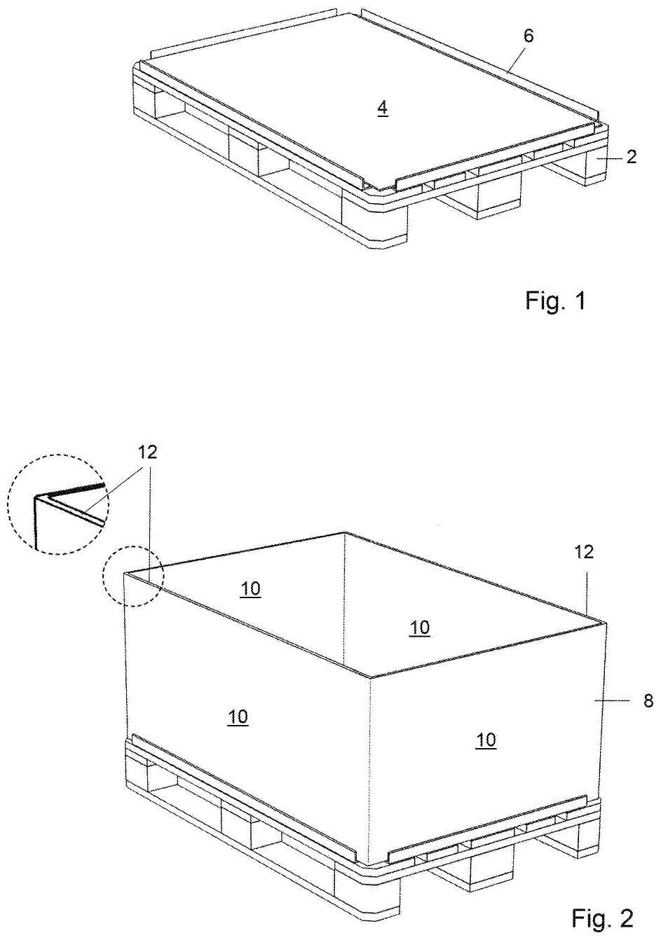

FIG. 1 shows a europallet 2 lying on the ground with a bottom part 4 placed thereon. The bottom part 4 can be provided with laterally attached, upwardly projecting sidewalls 6. A bottom ring 8 can be placed onto the bottom part 4, which is shown in FIG. 2.

In FIG. 2, it can be seen that the ring 8 has four upright sidewalls 10. The respective sidewalls 10 are connected to each other by the respective corners to neighboring sidewalls 10 so that the ring 8 is circumferentially closed. The ring 8 in the embodiment is erected such that a cuboid spatial shape is provided. Goods can be placed for packaging purposes into the interior of the ring 8.

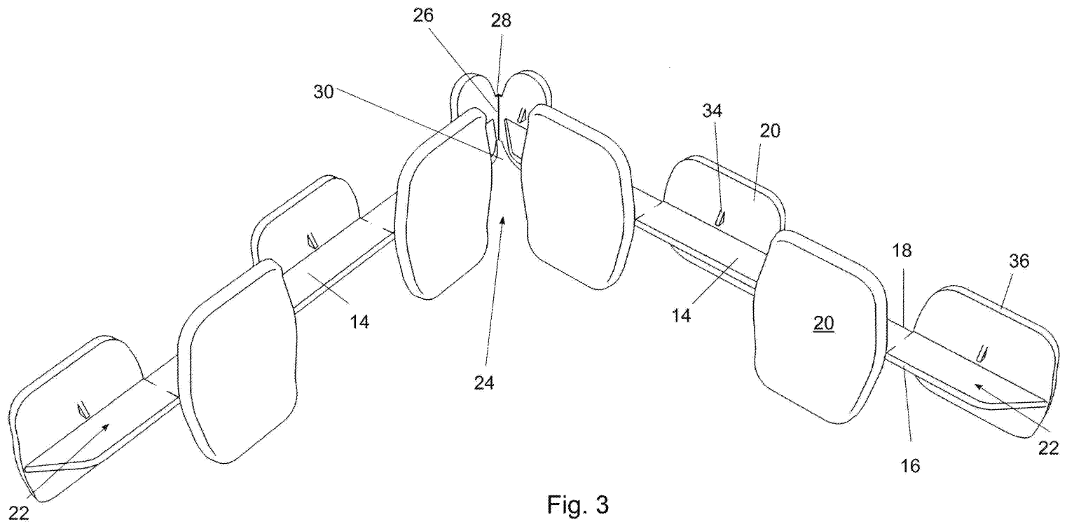

The ring 8 comprises an upwardly pointing top edge 12 onto which a support strip 14 can be placed. The support strip 14 is illustrated in more detail in FIG. 3. The support strip 14 comprises an inner edge 16 as well as an outer edge 18. In the region of the inner and outer edges 16, 18, there are clamping flaps 20 which extend from the support strip plane upwardly and downwardly. The illustration of FIG. 3 shows that the inwardly positioned clamping flaps 20 attached to the inner edge 16 project higher upwardly and downwardly than the clamping flaps 20 provided at the outer edge 18. The clamping flaps 20 delimit between them an insertion channel 22 into which the sidewalls 10 of the bottom and top ring 8, 38 can be inserted.

In FIG. 3, the support strip 14 is shown in an embodiment bent at a right angle. In the corner region 24 of a ring 8, 38, the bending location 26 is located in which in the embodiment the two legs of the support strip 14 are connected to each other only by the film hinge 28. The film hinge 28 connects two neighboring clamping flaps 20 which are arranged adjacent to each other in the region of the bending location 26. A material cutout 30 is provided in the support strip 14 which makes it possible that one of the two legs of the support strip 14 is pivoted by 90° in relation to the other leg to a support strip 14 extending across a corner.

In the view of FIG. 3, it can also be seen that the clamping flaps 20 each are provided with reinforcement ribs 32 which are provided in the rim area in the embodiment.

Also, there are barbs 34 at the side of the clamping flaps 20 facing the support strip 14. The barbs 34 can dig into the material of the sidewalls 10 when inserted into the insertion channel 22. The barb 34 is formed such that it counteracts a pull-out movement of a sidewall 10 out of the insertion channel 22. Also, the widened portions 36 can be seen in FIG. 3 which are formed at the inner surfaces of the clamping flaps 24 as insertion opening of the insertion channels 22.

In the embodiment, the clamping flaps 20 arranged at the inner edge 16 and the outer edge 18 are arranged spaced apart from each other, respectively; between the clamping flaps 20 at one side of the support strip 14 there are large free spaces. The clamping flaps 20 which are attached to the oppositely positioned inner and outer edges 16, 18 are however arranged displaced relative to each other in longitudinal direction of the support strip 14 so that at a location where at one side of the support strip 14 a clamping flap 20 is provided at the oppositely positioned side of the support strip 14 there is always no clamping flap 20 formed.

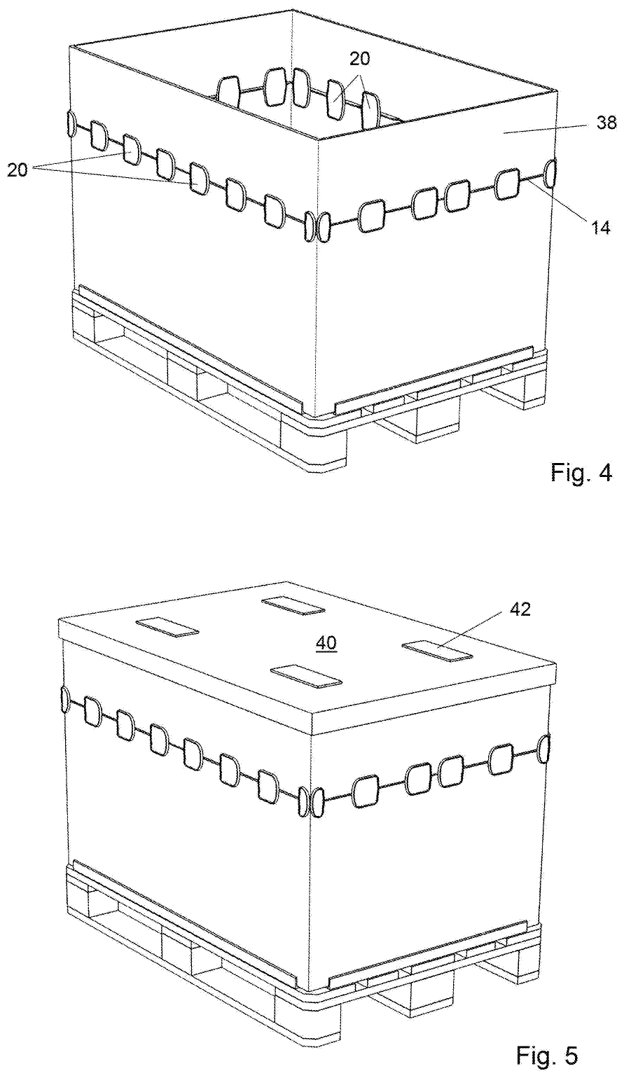

FIG. 4 now shows how the packaging looks after first the different support strips 14 are placed onto the top edges 12 of the sidewalls 10 of the ring 8 in the corner regions of the ring 8 and, subsequently, the top ring 38 is inserted into the upwardly projecting insertion channel 22 of the support strip 14. In this view, it can be seen that the clamping flaps 20 are connected at the outer side as well as at the inner side with the bottom ring 8 and the top ring 38 and connect these two rings 8, 38 to each other. Since the top ring 38 in its length dimensions and spatial shape corresponds to the bottom ring 8, sidewalls 10 are formed after attachment of the top ring 38 that are divided in their direction of height and are each formed by the surfaces of the rings 8 and 38 that are corresponding with each other. When comparing FIGS. 2 and 4, it can be seen that it is much easier to fill first the ring 8, as shown in FIG. 2, with the goods to be packaged prior to the top ring 38 being positioned on top.

According to the described principle, also more than two rings 8, 38 can be stacked on each other.

In FIG. 4, the support strips 14 are of a comparatively long design so that a connection and support of the top ring 38 with the bottom ring 8 results almost across the entire length of the top edge 12. In deviation from the embodiment, the support strip 14 can also be shorter, of course.

In FIG. 5, a packaging is illustrated onto which a cover part 14 has been placed. At the top surface of the cover part 40, slip-reducing elements 42 are applied by means of which sliding of a pallet that is placed onto the cover part 40 is at least made difficult.

When the afore described packaging is to be unpacked again, it is possible to perform the steps of assembly in reverse direction. Removing the goods packaged in the packaging is also easy for the recipient of the delivery when he lifts the top ring 38 off the bottom ring 8 in order to reach the goods which are arranged in the bottom region of the packaging.

The invention is not limited to the afore described embodiment. A person of skill in the art will have no difficulty in modifying the embodiment in a way appearing suitable to him in order to adapt it to a concrete situation of use.

What is claimed is:

1.-15. (canceled)

16. A packaging comprising:
bottom sidewalls configured to be unfolded from a flat folded position to a circumferentially closed bottom ring comprising a polygonal spatial shape, the bottom sidewalls vertically positioned in the circumferentially closed bottom ring and connected to each other at commonly formed corners of the circumferentially closed bottom ring;
top sidewalls configured to be unfolded from a flat folded position to a circumferentially closed top ring comprising a polygonal spatial shape, the top sidewalls vertically positioned in the circumferentially closed top ring and connected to each other at commonly formed corners of the circumferentially closed top ring;
angled support strips pushed onto top edges of the bottom sidewalls in at least two corner regions of the circumferentially closed bottom ring and extending across the commonly formed corners of the circumferentially closed bottom ring;
the angled support strips comprising clamping flaps formed at an inner edge and at an outer edge of the support strips, respectively, wherein the clamping flaps include first clamping flaps extending from a horizontal strip plane of the angled support strips in a direction toward a bottom of the packaging and further include second clamping flaps extending from the horizontal strip plane in a direction toward a top of the packaging;
wherein the first clamping flaps delimit between them a first insertion channel following a length extension of the support strips, wherein the top edges of the bottom sidewalls are inserted into the first insertion channels of the angled support strips;
wherein the second clamping flaps delimit between them a second insertion channel following the length extension of the support strips, wherein bottom edges of the top sidewalls are inserted into the second insertion channels of the support strips;
wherein length dimensions and the polygonal spatial shape of the circumferentially closed top ring correspond to length dimensions and the polygonal spatial shape of the circumferentially closed bottom ring so that the top sidewalls and the bottom sidewalls arranged on top of each other and connected to each other by the angled support strips form flat, commonly formed outer surfaces of the packaging.

17. The packaging according to claim 16, configured to be placed with the bottom sidewalls into a bottom part.

18. The packaging according to claim 16, further comprising a cover part placed onto the top sidewalls.

19. The packaging according to claim 18, further comprising slip-reducing elements applied to a top side of the cover part.

20. The packaging according to claim 16, wherein the first clamping flaps formed at the inner edge are spaced apart from each other and wherein the first clamping flaps arranged at the outer edge are spaced apart from each other.

21. The packaging according to claim 20, wherein the first clamping flaps formed at the inner edge are displaced relative to the first clamping flaps arranged at the outer edge.

22. The packaging according to claim 16, wherein the second clamping flaps formed at the inner edge are spaced apart from each other and wherein the second clamping flaps arranged at the outer edge are spaced apart from each other.

23. The packaging according to claim 22, wherein the second clamping flaps formed at the inner edge are displaced relative to the second clamping flaps arranged at the outer edge.

24. The packaging according to claim 16, wherein the angled support strips have a bending location with a material cutout or with a portion with reduced material strength.

25. The packaging according to claim 24, wherein, in a region of the bending location, the first and second clamping flaps arranged at the outer edge and neighboring the bending location form a corner of the angled support strip and are connected to each other by a film hinge.

26. The packaging according to claim 16, wherein the first and second clamping flaps formed at the inner edge project farther away from the horizontal strip plane than the first and second clamping flaps formed at the outer edge.

27. The packaging according to claim 16, wherein the first and second clamping flaps have reinforcement ribs.

28. The packaging according to claim 16, wherein the first and second clamping flaps have an inner side facing the angled support strip, wherein the inner side comprises clamping noses or barbs projecting from a surrounding surface of the inner side.

29. The packaging according to claim 16, wherein the bottom sidewalls and the top sidewalls are made of corrugated cardboard.

30. The packaging according to claim 16, wherein the first and second clamping flaps have a shaped portion widening the first and second insertion channels at an insertion end in relation to deeper sections of the first and second insertion channels.

31. A method for producing a packaging, the method comprising:
erecting bottom sidewalls from a flat folded position to a circumferentially closed bottom ring comprising a polygonal spatial shape, the bottom sidewalls vertically positioned in the circumferentially closed bottom ring;
pushing angled support strips onto top edges of the bottom sidewalls in at least two or more corner regions of the polygonal spatial shape so that the angled supports strips extend across the commonly formed corners of the circumferentially closed bottom ring, the angled support strips comprising clamping flaps formed at an inner edge and at an outer edge of the angled support strips, respectively, wherein the clamping flaps include first clamping flaps extending from a horizontal strip plane of the angled support strips in a direction toward a bottom of the packaging and further include second clamping flaps extending from the horizontal strip plane in a direction toward a top of the packaging, wherein the first clamping flaps delimit between them a first insertion channel following a length extension of the angled support strips and wherein the second clamping flaps delimit between them a second insertion channel following the length extension of the angled support strips, wherein the top edges of the bottom sidewalls are inserted into the first insertion channels of the angled support strips;
unfolding top sidewalls from a flat folded position to a circumferentially closed top ring comprising a polygonal spatial shape, the top sidewalls vertically positioned in the circumferentially closed top ring;
inserting bottom edges of the top sidewalls into the second insertion channels of the angled support strips;
matching length dimensions and the polygonal spatial shape of the circumferentially closed top ring to length dimensions and the polygonal spatial shape of the circumferentially closed bottom ring so that the top sidewalls and the bottom sidewalls arranged on top of each other and connected to each other by the angled support strips form flat, commonly formed outer surfaces of the packaging.

32. The method according to claim 31, further comprising placing the bottom sidewalls into a bottom part.

33. The method according to claim 31, further comprising placing a cover part onto the top sidewalls.

34. The method according to claim 33, further comprising applying slip-reducing elements to a top side of the cover part.

35. The method according to claim 31, further comprising configuring the angled support strips such that the first clamping flaps formed at the inner edge are spaced apart from each other, that the first clamping flaps arranged at the outer edge are spaced apart from each other, and that the first clamping flaps formed at the inner edge are displaced relative to the first clamping flaps arranged at the outer edge.

36. The method according to claim 31, further comprising configuring the angled support strips such that the second clamping flaps formed at the inner edge are spaced apart from each other, that the second clamping flaps arranged at the outer edge are spaced apart from each other, and that the second clamping flaps formed at the inner edge are displaced relative to the second clamping flaps arranged at the outer edge.

37. The method according to claim 31, further comprising configuring the angled support strips such that the angled support strips have a bending location with a material cutout or with a portion with reduced material strength.

38. The method according to claim 37, further comprising configuring the angled support strips such that, in a region of the bending location, the first and second clamping flaps, arranged at the outer edge and neighboring the bending location, form a corner of the angled support strip and are connected to each other by a film hinge.

39. The method according to claim 31, further comprising configuring the angled support strips such that the first and second clamping flaps formed at the inner edge project farther away from the horizontal strip plane than the first and second clamping flaps formed at the outer edge.

40. The method according to claim 31, further comprising configuring the angled support strips such that the first and second clamping flaps have reinforcement ribs.

41. The method according to claim 31, further comprising configuring the angled support strips such that the first and second clamping flaps have an inner side facing the angled support strip and comprising clamping noses or barbs projecting from a surrounding surface of the inner side.

42. The method according to claim 31, further comprising producing the bottom sidewalls and the top sidewalls of corrugated cardboard.

43. The method according to claim 31, further comprising configuring the angled support strips such that the first and second clamping flaps have a shaped portion widening the first and second insertion channels at an insertion end in relation to deeper sections of the first and second insertion channels.
